(19) United States
(12) Patent Application Publication
(10) Pub. No.: US 2025/0276927 A1
(43) Pub. Date: Sep. 4, 2025

(54) Extracting Carbon Dioxide from Seawater Using Substrate-Induced Nucleation

(71) Applicant: Captura Corp., Pasadena, CA (US)

(72) Inventors: Vahid Gholami Ghamsari, Pasadena, CA (US); Zhiyuan Qi, Pasadena, CA (US); Ibadillah Ardhi Digdaya, Whittier, CA (US); Chengxiang Xiang, San Marino, CA (US)

(73) Assignee: Captura Corp., Pasadena, CA (US)

(21) Appl. No.: 19/067,581

(22) Filed: Feb. 28, 2025

Related U.S. Application Data
(60) Provisional application No. 63/560,325, filed on Mar. 1, 2024.

(51) Int. Cl. C02F 9/00; B01D 19/00; B01D 63/02; C02F 1/00; C02F 1/20; C02F 1/44; C02F 1/52; C02F 1/66; C02F 101/10; C02F 103/08

(52) U.S. Cl. CPC C02F 9/00; B01D 19/0005; B01D 19/0031; B01D 63/02; C02F 1/004; C02F 1/20; C02F 1/441; C02F 1/52; C02F 2001/5218; C02F 1/66; C02F 2101/10; C02F 2103/08

(57) ABSTRACT

In a general aspect, carbon dioxide is extracted from seawater using substrate-induced nucleation. In certain aspects, a method of removing carbon dioxide from seawater includes receiving seawater and processing the seawater in the reactor. The reactor includes a substrate, and the seawater includes dissolved inorganic carbon. A substrate-induced nucleation process is performed on a surface of the substrate, during which the dissolved inorganic carbon is transformed to carbonate crystal precipitates and carbon dioxide gas. The method further includes extracting at least a portion of the carbon dioxide gas from the processed seawater.

### CROSS-REFERENCE TO RELATED APPLICATIONS

This application claims priority to U.S. Provisional Patent Application No. 63/560,325, filed Mar. 1, 2024, entitled “Extracting Carbon Dioxide from a Solution using Substrate-Induced Nucleation.” The above-referenced priority document is incorporated herein by reference in its entirety.

### TECHNICAL FIELD

The following description relates to extracting carbon dioxide from seawater using substrate-induced nucleation.

### BACKGROUND

Direct ocean capture (DOC) technologies are a promising option for servicing a very large and diverse carbon removal industry needed to mitigate legacy carbon dioxide emissions that are exacerbating anthropogenic climate change. Robust, energy efficient, and low-cost strategies for direct removal of carbon dioxide from seawater and other natural waters are focused on addressing challenges and opportunities specifically found in operation in an oceanic environment.

### BRIEF DESCRIPTION OF THE DRAWINGS

FIG. 1 is a schematic diagram showing aspects of an example direct ocean capture system.

FIG. 2 is a schematic diagram showing aspects of an example direct ocean capture system.

FIG. 3 is a schematic diagram showing aspects of an example direct ocean capture system.

FIG. 4 is a schematic diagram showing aspects of an example direct ocean capture system.

FIG. 5 is a flow chart showing aspects of an example direct ocean capture process.

### DETAILED DESCRIPTION

In some aspects of what is described here, a substrate-induced nucleation reaction is used to remove dissolved inorganic carbon from seawater. In some instances, a reactor in a direct ocean capture (DOC) system includes a substrate where the substrate-induced nucleation process is produced and sustained. For instance, when a surface of the substrate is in contact with the seawater, the substrate-induced nucleation reaction process may transform the dissolved inorganic carbon (DIC) in the seawater to carbonate crystal precipitates and carbon dioxide gas. The DIC in the seawater can thereby be reduced, and the carbon dioxide gas can be removed from the reactor.

In some implementations, the reactor is a fluidized bed reactor where the substrate in the form of particles can be suspended in the fluidized bed reactor. In some implementations, the reactor includes a hollow fiber membrane contactor module where the substrate in the form of particles can be supported on shell sides of the hollow fiber membranes. Other types of systems and structures may be used, in some cases.

In some implementations, the systems and techniques described here can provide technical advantages and improvements. In some instances, the systems and techniques presented here can be used to selectively remove the DIC in seawater to reduce its concentration in seawater. The systems and techniques presented here may reduce energy consumption in direct ocean capture by facilitating nucleation at milder conditions, reduce activation-energy needed for crystal formation, and reduce mechanical and thermal energy needs. For example, the systems and techniques may enable efficient carbon dioxide extraction in a DOC system; and may reduce levelized cost of carbon dioxide from the DOC system. In some instances, the systems and techniques can also reduce competition for useful land; allow access to oceanic carbon dioxide storage sites; and produce valuable carbon dioxide streams offshore for fuel and chemical synthesis; and allow a direct reversal of ocean acidification caused by anthropogenic carbon dioxide emissions. In some instances, the systems and methods presented here can be also used to remove carbon dioxide from other types of solutions that contain DIC. In some cases, a combination of these and potentially other advantages and improvements may be obtained.

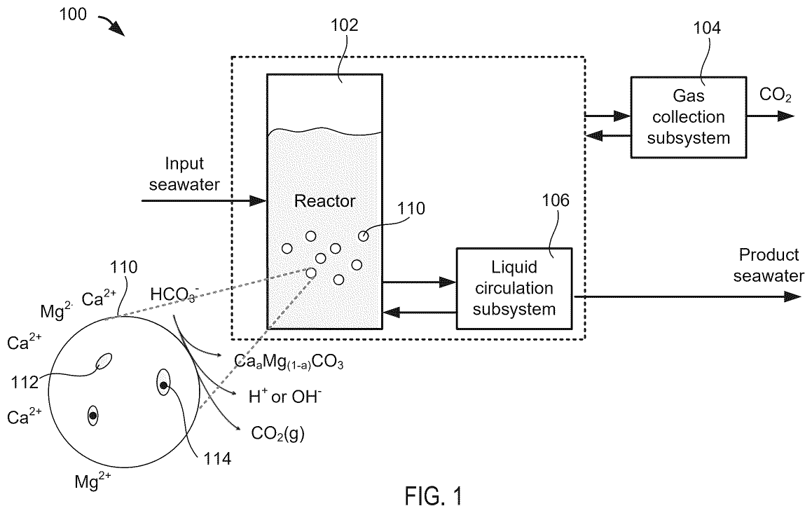

FIG. 1 is a schematic diagram showing aspects of an example DOC system 100. The example DOC system 100 shown in FIG. 1 includes a reactor 102 configured to receive input seawater and process the input seawater using a substrate-induced nucleation process. For example, the reactor 102 may include one or more substrates that directly contact the seawater and induce the nucleation process. The seawater processed by the DOC system 100 may be or include water from one or more of a variety of sources, for example, from an ocean, a sea, or another source of seawater containing DIC.

In some implementations, a substrate-induced nucleation is a process where a solid surface facilitates the formation of new crystals from a supersaturated solution by lowering the energy barrier for nucleation. In some implementations, the substrate's surface properties-such as roughness, chemical functionality, or lattice structure-provide preferential sites that promote heterogeneous nucleation, leading to the orderly arrangement of depositing species. In some implementations, the substrate-induced nucleation enables crystal formation under milder conditions compared to spontaneous, homogeneous nucleation in the bulk. In some instances, the substrate-induced nucleation process may be implemented as the example direct carbon removal processes described in the example systems 100, 200, 300, 400 in FIGS. 1-4.

In some implementations, the substrate-induced nucleation process can remove at least a portion of the DIC from the input seawater and produce processed seawater with a reduced concentration of the DIC. The example DOC system 100 further includes a gas collection subsystem 104 and a liquid circulation subsystem 106 which are fluidically connected to each other and to the reactor 102 through liquid pipelines/channels, gas conduits, etc. In some implementations, the gas collection subsystem 104 is configured to create a driving force for extracting the dissolved carbon dioxide gas from the processed seawater and to collect the extracted carbon dioxide gas from the reactor 102; and the liquid circulation subsystem 106 is configured to cause the input seawater to flow into the reactor 102 and cause the processed seawater to flow out of the reactor 102. The example DOC system 100 may include additional or different features, and the components of the example DOC system 100 may operate as described with respect to FIG. 1 or in another manner.

In some implementations, the input seawater received at the example DOC system 100 has a pH value in a range of 7.5-11. In some instances, the input seawater received by the reactor 102 may have a pH value of 8.1. In some instances, the pH of the input seawater can be adjusted for desired kinetic parameters. In certain instances, the input seawater can be preprocessed. For example, prior to being passed to the reactor 102, the input seawater can be filtered to remove living organisms, or other large debris from the input seawater. In some instances, the example DOC system 100 may include devices and components that can be configured to preprocess and condition the input seawater in another manner, e.g., heating, for a later process. In some implementations, the input seawater includes supersaturated minerals and salts, including calcium carbonate, magnesium carbonate, and other salt. In some implementations, the DIC in the input seawater includes three chemical forms in equilibrium, e.g., dissolved carbon dioxide gas, bicarbonate ion and carbonate ion.

In some implementations, the reactor 102 includes a substrate 110 which is a template-assisted crystallization (TAC) substrate (or a nucleation-assisted crystallization (NAC) substrate). The substrate 110 in the reactor 102 includes a surface with structured templates 112. A structured template 112 on the surface of the substrate 110 includes a predefined surface or material that can lower an activation energy for crystal formation; and can provide a scaffold for directing and controlling crystal nucleation and growth in a specific orientation, morphology or size. In some instances, the structured templates 112 of the substrate 110 may include surface decorations, functionalization, or a coating on the surface of the substrate 110 which can facilitate the crystal formation, stabilize the substrate, and improve performance of the substrate for processing the input seawater with a high concentration of calcium and magnesium ions (Ca²⁺ and Mg²⁺). The material of the substrate 110 may be selected according to the desired technical properties of the substrate 110 (e.g., size, template, material, stability, etc.), specific reaction environment (e.g., pressure, temperature, etc.), and other considerations. In some instances, the substrate 110 may be determined according to the type of reactor 102. As shown in FIG. 1, the reactor 102 includes multiple substrates 110 suspended in the input seawater. In some instances, the multiple substrates 110 may be incorporated in the reactor 102 in another manner.

In some implementations, the substrate 110 with structured templates 112 is configured to promote heterogenous crystallization rather than random precipitation. During operation, calcium, magnesium and bicarbonate ions from the input seawater are attracted to the structured templates 112 on the substrate 110 and begin to deposit on the structured templates 112. Seed crystals 114 start to grow in the structured templates 112. In some instances, micro crystals can break free from the structured templates 112 and form crystal precipitates in the processed seawater. During operation, the gas collection subsystem 104 and the liquid circulation subsystem 106 are controlled to create a controlled environment to sustain the substrate-induced nucleation reaction in the reactor 102. When interfacing with the input seawater, the substrate serves as a media on which initial crystal nuclei form and from which crystal growth proceeds. In some instances, the crystal precipitates formed on the substrate 110 are carbonate crystal precipitates which include calcium carbonate (CaCO₃) crystals, magnesium carbonate (MgCO₃) crystals, and other types crystals (magnesium hydroxide (Mg(OH)₂) crystals). In some instances, the crystals may continue to form and finally detach from the surface of the substrate 110 and form solid precipitates. During the formation of the carbonate crystals on the surface of the substrate 110, carbon dioxide gas (e.g., in forms of micro bubbles) formed during the reaction can dissolve in the processed seawater. In certain examples, the carbon dioxide gas can be stripped using a degassing process by operation of the gas collection subsystem 104; and the carbonate crystal precipitates can be collected by operation of the liquid circulation subsystem 106. In some instances, at least some of the carbonate crystal precipitates may be collected and converted to carbon dioxide gas which can be collected and used in other types of process. In some implementations, the input seawater may be obtained from a cooling process of a nuclear power plant, from a desalination plant, etc. In some instances, the example DOC system 100 can be used to process a brine solution (e.g., affluent from mining process), or another type of solution that contains DIC.

In some implementations, the generic chemical reaction at the structured templates 112 on the surface of the substrate 110, e.g., a substrate-induced nucleation reaction, can be described as the following, when the precipitation rate of the carbonate crystal precipitates exceeds the extraction rate of the dissolved carbon dioxide gas:

$$( 1 + x ) ( a {Ca}^{2 +} + ( 1 - a ) {Mg}^{2 +} ) + 2 {HCO}_{3}^{-} \to ( 1 + x ) {Ca}_{a} {Mg}_{( 1 - a )} {CO}_{3} + ( 1 - x ) {CO}_{2} + 2 x {H}^{+} + ( 1 - x ) {H}_{2} O \qquad ( 1 )$$

In some instances, when the extraction rate of the dissolved carbon dioxide gas exceeds the precipitation rate of the carbonate crystal precipitates, the substrate-induced nucleation reaction may be described as:

$$( 1 - x ) ( a {Ca}^{2 +} + ( 1 - a ) {Mg}^{2 +} ) + 2 {HCO}_{3}^{-} \to ( 1 - x ) {Ca}_{a} {Mg}_{( 1 - a )} {CO}_{3} + ( 1 + x ) {CO}_{2} + 2 x {OH}^{-} + ( 1 - x ) {H}_{2} O \qquad ( 2 )$$

The extraction efficiency of the dissolved carbon dioxide gas and the pH of the processed seawater can be independently tuned through the precipitation rates of the carbonate crystal precipitates and the extraction rates of the dissolved carbon dioxide gas. For example, when the extraction of carbonate crystal precipitates increases, the substrate-induced nucleation reaction may be performed following the acid route described in equation (1), during which the pH value of the processed seawater can be reduced. For another example, when the extraction of the carbon dioxide gas from the reactor increases (e.g., by increasing the degassing rate of the carbon dioxide gas from the reactor 102), the substrate-induced nucleation reaction may be performed following the alkaline route described in equation (2), during which the pH value of the processed seawater can be increased. In some instances, the substrate-induced nucleation reaction may have a reaction time of approximately 5 seconds or another time duration depending on the type of substrate 110 and its interaction with the input seawater. In some instances, the extraction rate of the dissolved carbon dioxide gas can be adjusted by varying the extraction methods and operating parameters of an extraction method used.

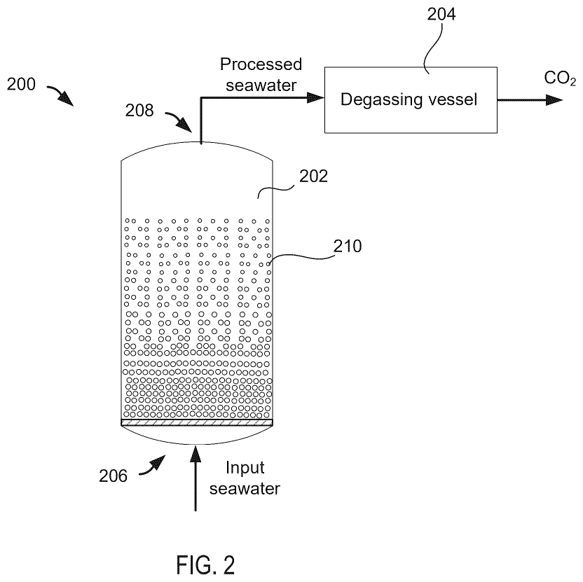

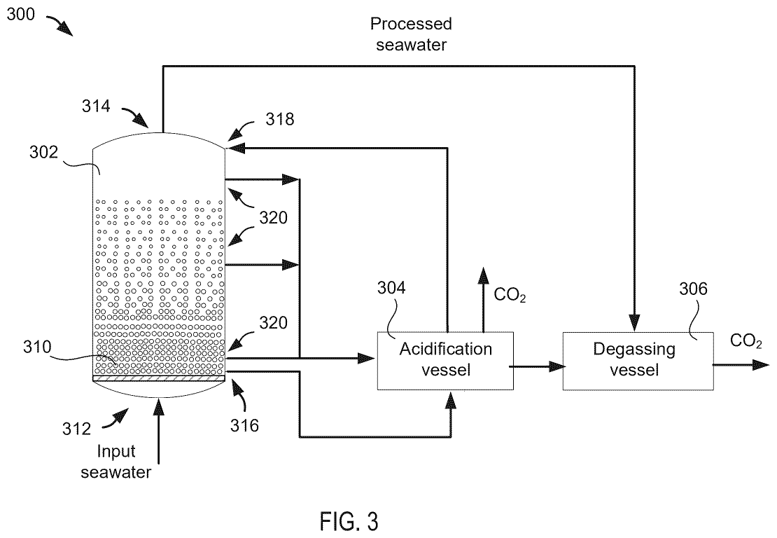

In certain instances, the reactor 102 may be implemented as a fluidized bed reactor (e.g., the reactor 202, 302 shown in FIGS. 2-3) in which the substrate 110 may be suspended. In this case, the substrate 110 may include nanoparticles, microparticles, seed crystals, silica-based substrate (e.g., silica gel or sand), polymeric beads, metal oxides particles, ceramic beads, graphene, metal-organic frameworks (MOFs), or other types of substrates. In some instances, the reactor 102 may be implemented as a membrane contactor. In some instances, the substrate 110 may be formed on surfaces on a supporting structure, e.g., silica or metal oxide-coated surfaces. In some instances, the substrate can be supported on membranes of the membrane contactor. In some instances, the membranes may be carbon dioxide selective which allows the dissolved carbon dioxide gas originally present in the input seawater and the dissolved carbon dioxide gas formed during the substrate-induced nucleation process to be separated from the process seawater.

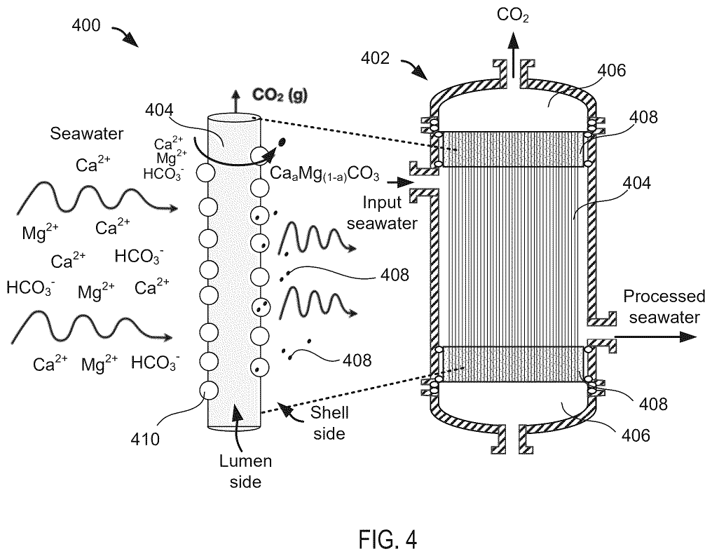

In some instances, the membrane contactor may be implemented as a hollow fiber membrane contactor module (e.g., the hollow fiber membrane contactor module 400 shown in FIG. 4), or may be configured in another manner in the reactor 102. In this case, the substrate 110 may be supported on surfaces of hollow fiber membranes on shell sides. Hollow fiber membranes in the module may be carbon dioxide selective which allow the dissolved carbon dioxide gas from the processed seawater to be selectively transported, e.g., from shell sides (e.g., the outer side of a hollow fiber membrane contacting the seawater) to lumen sides (e.g., the inner side of a hollow fiber membrane for communicating transported carbon dioxide gas). In some implementations, a CO₂-selective hollow fiber membrane allows carbon dioxide gas to pass through while blocking or slowing down other gases in the seawater, e.g., selectively transport carbon dioxide gas over other gases. For example, the hollow fiber membrane 404 has a selectivity of the dissolved carbon dioxide in the input seawater over other dissolved gases in the input seawater (e.g., oxygen, nitrogen, etc.). In some instances, the hollow fiber membranes have a CO₂ selective permeability which is achieved through the membrane's physical and chemical properties. In some instances, the hollow fiber membranes may be implemented as the hollow fiber membranes 404 in FIG. 4 or in another manner. In certain examples, the substrate 110 may be implemented in another manner, including lithographic and patterned surfaces (e.g., micropatterned silicon or polymer templates).

In some instances, the reactor 102 may be a bubbling fluidized bed reactor. The gas collection subsystem 104 can be configured to supply carrier gas to the input seawater containing the substrate 110 in the form of solid particles and to extract the product gas from the reactor 102 that includes carbon dioxide gas. The carrier gas can be supplied to the reactor 102 from the bottom of the reactor 102 through one or more gas distributor. Bubbles are formed in the reactor 102. As the bubbles travel from the bottom to the top of the reactor 102, the solid particles which are initially resting at the bottom of the reactor 102 are lifted causing the solid particles to mix with the input seawater. The gas collection subsystem 104 can create a vacuum pressure in the headspace of the reactor 102 to facilitate the extraction of dissolved carbon dioxide gas in the processed seawater. When the reactor 102 includes a hollow fiber membrane contactor module, the gas collection subsystem 104 can be configured to supply sweep gas to lumen sides of hollow fiber membranes in the contactor module, apply vacuum pressure to the lumen sides of the hollow fiber membranes, and collect carbon dioxide gas from the lumen sides of the hollow fiber membranes. In some instances, the gas collection subsystem 104 includes gas tanks, vacuum pumps, vacuum relief valves, non-return valves, regulators, connectors, and other devices for creating a pressure differential and thus a driving force that drives the dissolved carbon dioxide gas from the shell sides to the lumen sides. In some instances, the carbon dioxide gas collected from the reactor 102 may be collected and stored for later processing. In some instances, the gas collection subsystem 104 may include devices or components to enable other functions in the example DOC system 100.

In some instances, the reactor 102 may be a circulating fluidized bed reactor in which the liquid circulation subsystem 106 is configured to create a flow of the input seawater to fluidize the substrates 110 causing the substrates 110 to be well mixed and suspended in the input seawater for efficient substrate induced nucleation process. In some implementations, the liquid circulation subsystem 106 is configured to remove the processed seawater from the reactor 102. In some instances, the processed seawater from the reactor 102 may include the reacted substrates (e.g., substrates 110 coated with carbonate crystals 114), carbonate crystal precipitates and dissolved carbon dioxide gas can be further processed by devices and components of the liquid circulation subsystem 106 to filter out or clarify the carbonate crystal precipitates and the reacted substrate from the processed seawater. In some instances, the carbonate crystal coating on the surfaces of the reacted substrate can be removed; and the substrate 110 can be regenerated. The regenerated substrate can be communicated back to the reactor 102 by operation of the liquid circulation subsystem 106. The product seawater includes a reduced concentration of the DIC. In some instances, the product seawater from the liquid circulation subsystem 106 can be treated (e.g., filtered, neutralized, etc.) before returning back to the ocean. In some instances, the liquid circulation subsystem 106 can be operated to directly cause the processed seawater from the reactor 102 to flow directly back to the ocean without further processing.

In certain instances, an acidification process can be used to convert the carbonate crystals on the reacted substrates and carbonate crystal precipitates from the processed seawater into carbon dioxide gas. In some implementations, the acidification process of the reacted substrate includes mixing an acidic solution with the processed seawater. In some instances, the acidic solution may include chloric acid (HCl), or other types of acid. In some instances, after acidifying the reacted substrate, pristine structured templates of the substrate are exposed which allows future substrate-induced nucleation reaction to occur. In some instances, the acidic solution may be generated onsite as part of the example DOC system 100 using an electrodialysis process by operation of one or more electrochemical cells or obtained in another manner. In some implementations, the carbonate crystal precipitates in the processed seawater and the reacted substrate can be collected and separated from the processed seawater by operation of the liquid circulation subsystem 106. The acidic solution introduced to the collected precipitates and the reacted substrate during the acidification process can react with carbonate crystals to convert the carbonate crystals to carbon dioxide gas.

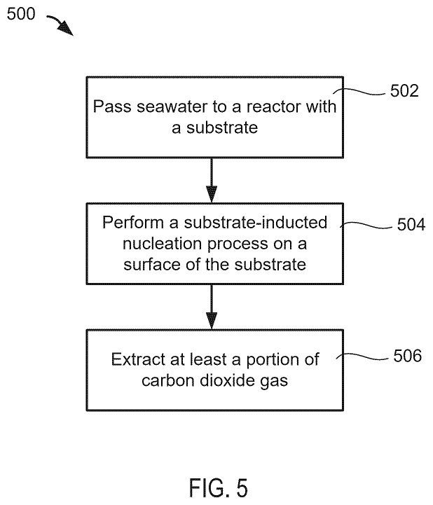

In some instances, the DOC system 100 includes a control system communicably connected to devices and components configured to monitor, tune and otherwise control parameters of the substrate-induced nucleation process in the reactor 102, which include temperature, concentration, pH value, flow rate, striping rate of dissolved carbon dioxide gas, pressure, flow rate, reaction time, etc. In some instances, the control system may include data processing apparatus, processing units, and memory units to execute and store programs to operate components and devices of the example DOC system 100 in FIG. 1 and perform the operations in the example process 500 in FIG. 5.

FIG. 2 is a schematic diagram showing aspects of an example DOC system 200. The example DOC system 200 is configured to remove DIC in seawater. As shown in FIG. 2, the example DOC system 200 includes a reactor 202 which receives input seawater that includes DIC and is configured to sustain a substrate-induced nucleation reaction to reduce the concentration of the DIC in the input seawater. In some instances, the example DOC system 200 is configured to perform operations in the example process 500 shown in FIG. 5. The example DOC system 200 may include additional or different features, and the components of the example DOC system 200 may operate as described with respect to FIG. 2 or in another manner. For example, the example DOC system 200 further includes a gas collection subsystem and a liquid circulation subsystem which are fluidically connected to each other and to the reactor 202 through liquid pipelines/channels, gas conduits, etc. In some implementations, the gas collection subsystem may be configured to create a driving force for extracting the carbon dioxide gas from the processed seawater and to collect the extracted carbon dioxide gas; and the liquid circulation subsystem may be configured to cause the input seawater to flow into the reactor 202 and cause the processed seawater to flow out of the reactor 202.

In some implementations, the reactor 202 is a fluidized bed reactor which includes an input port 206 at which a stream of the input seawater is received, and an output port 208 at which a stream of the processed seawater is transported out. As shown in FIG. 2, the reactor 202 includes substrates 210 in the form of particles. In some instances, the reactor 202 is a liquid-fluidized bed reactor; and the stream of the input seawater can be adjusted, changed or otherwise controlled to suspend the particles in the liquid phase (e.g., seawater) in the reactor 202. For example, the input seawater can be pumped into the reactor 202 upward through a bed of particles causing them to suspend in the seawater and fluidize them. In some instances, the reactor 202 may be another type of fluidizing bed reactor; and the substrates 210 may be suspended in the seawater in the reactor 202 in another manner.

In some instances, each substrate 210 is a template-assisted crystallization substrate or a nucleation-assisted crystallization substrate. Each substrate 210 in the reactor 202 includes a surface with structured templates. In some implementations, the substrates 210 in the reactor 202 are configured to promote heterogenous crystallization rather than random precipitation. During operation, Ca²⁺, Mg²⁺, and HCO₃⁻ ions from the input seawater are attracted to the structured templates on the substrates 210 and begin to deposit on the structured templates. Seed crystals start to grow in the structured templates. In some instances, micro crystals can break free from the structured templates and form carbonate crystal precipitates in the processed seawater. In some instances, the substrates 210 may be implemented as the substrates 110 in FIG. 1 or in another manner.

During operation, the input seawater including DIC is received at the input port 206 of the reactor 202; and once it is in contact with the substrates 210, a substrate-induced nucleation reaction occurs at the structured templates on surfaces of the substrates 210, during which carbonate crystals and carbon dioxide gas form within the reactor 202. The processed seawater including dissolved carbon dioxide gas and carbonate crystal precipitates detached from the surfaces of the substrates 210 can be collected from the output port 208 of the reactor 202. In some instances, the processed seawater at the output port 208 may also include a portion of the DIC initially presented in the input seawater and a portion of the suspended substrates 210. As shown in FIG. 2, the processed seawater is transferred out of the reactor 202 to a degassing vessel 204 by operation of a liquid circulation subsystem. In some instances, the processed seawater from the reactor 202 can be further processed in the degassing vessel 204, e.g., in which a degassing process to remove the dissolved carbon dioxide gas can be performed. In some implementations, a degassing vessel 204 includes a vacuum column where a vacuum pressure is applied to extract the dissolved carbon dioxide gas from the processed seawater. In some implementations, the degassing vessel 204 includes a bubbe column where a CO₂-lean carrier gas (e.g., air, nitrogen, etc.) is bubbled through the processed seawater to extract the dissolved carbon dioxide gas. In some implementations, the degassing vessel 204 includes a contact module including one or more carbon dioxide selective membranes where the dissolved carbon dioxide gas is selectively transported from the processed seawater on one side of one or more membranes to the opposite side of the one or more membranes. In some instances, an atmospheric extraction method can be used to degas the processed seawater for extracting the dissolved carbon dioxide gas. In some instances, another type of degassing vessel for performing another degassing process may be used. In some instances, the processed seawater before degassing may be preprocessed to filter out or clarify the carbonate crystal precipitates, the reacted substrates with carbonate crystal precipitates on the surfaces, agglomerate materials containing carbonate crystal precipitates, or other solids. In some instances, the product seawater after degassing may be processed to collect the carbonate crystal precipitates before being returned to the ocean. In some instances, the filtered-out carbonate crystal precipitates may be collected for later processing.

In some instances, the example DOC system 200 may include devices or subsystems that can be configured to monitor the suspension of particles in the reactor 202. For example, the example DOC system 200 may include a control system that includes a computer system that is communicably connected to sensors (e.g., pH sensor, pressure sensors, optical sensors, ultrasound sensors, imaging sensors, or other sensors to measure or visualize particle distribution, bubbling, slugging, solid distribution and movement, measure pH values, or measure other conditions in the reactor 202. In some instances, the control system may be connected to devices and components that can be used to adjust and control the fluidizing condition in the reactor 202. In some instances, the control system can be configured to prevent settling and maintain fluidization state; avoid excessive substrate loss; ensure efficient mixing and reaction rate; and optimize the process performance.

In some instances, the example DOC system 200 may perform the degassing reaction in the reactor 202 without transferring the processed seawater out to a separate degassing vessel 204. In this case, the reactor 202 may be connected to a gas collection subsystem that can perform the degassing operation. In some instances, the reactor 202 may be connected to vacuum pumps for performing vacuum extraction. In some examples, the reactor 202 may be connected to one or more gas distributors for receiving a CO₂-lean carrier gas and performing gas extraction (e.g., air extraction or inert gas extraction). In some instances, the gas collections subsystem may include units or components that can further extract the carbon dioxide gas from the product gas before being stored for later processing. In some instances, the vacuum extraction and gas extraction can be simultaneously performed in the reactor 202 to enhance degassing efficiency. In this case, the reactor 202 may be connected to a vacuum pump and one or more gas distributor for performing vacuum-assisted gas extraction. When the degassing is performed in the reactor 202, the processed seawater transferred out of the output port 208 of the reactor 202 may not include a significant amount of dissolved carbon dioxide. Over time, crystal deposits may detach from the surfaces of the substrates 210; and the substrates 210 can be regenerated for subsequent formation of carbon crystal precipitates on the substrates 210 at the structured templates.

FIG. 3 is a schematic diagram showing aspects of an example DOC system 300. The example DOC system 300 is configured to remove DIC in seawater. As shown in FIG. 3, the example DOC system 300 includes a reactor 302 which receives input seawater that includes DIC and configured to process the input seawater by sustaining a substrate-induced nucleation reaction to reduce the concentration of the DIC in the input seawater. In some instances, the example DOC system 300 is also configured to remove or reduce the concentration of dissolved carbon dioxide gas in the input seawater. The example DOC system 300 further includes an acidification vessel 304 and a degassing vessel 306 fluidically connected to one another and to the reactor 302 through liquid pipelines, gas conduits, connectors, etc. In some instances, the example DOC system 300 is configured to perform operations in the example process 500 shown in FIG. 5. The example DOC system 300 may include additional or different features, and the components of the example DOC system 300 may operate as described with respect to FIG. 3 or in another manner.

In some implementations, the reactor 302 is a fluidized bed reactor. As shown in FIG. 3, the reactor 302 includes substrates 310. The substrate 310 is a template-assisted crystallization substrate (or a nucleation-assisted crystallization substrate). Each substrate 310 in the reactor 302 includes a surface with structured templates. In some implementations, the substrate 310 with structured templates is configured to promote heterogenous crystallization rather than random precipitation. During operation, Ca²⁺, Mg²⁺, and HCO₃⁻ ions from the input seawater are attracted to the structured templates on the substrates 310 and begin to deposit on the structured templates. Seed crystals start to grow in the structured templates. In some instances, micro crystals can break free from the structured templates and form carbonate crystal precipitates in the processed seawater. In some instances, the substrates 310 may be implemented as the substrates 110, 210 in FIGS. 1-2 or in another manner.

In some implementations, the reactor 302 includes multiple input and output ports at various elevations of the reactor 302. As shown in the example in FIG. 3, the reactor 302 includes a liquid input port 312 for receiving a stream of input seawater and a return port 318 for receiving a stream of slurry containing regenerated substrates from the acidification vessel 304. The reactor 302 further includes a first output port 316 at the lowest end (e.g., bottom) of the reactor 302 configured to communicate a slurry containing agglomerate material and processed seawater out of the reactor 302 for further processing. The agglomerate material in the slurry at port 316 may contain reacted substrates and carbonate crystal precipitates. The reactor 302 includes a second output port 314 located at the highest end (e.g., top) of the reactor 302 configured to primarily communicate the processed seawater out of the reactor 302. The processed seawater at the port 314 includes dissolved carbon dioxide gas originally dissolved in the input seawater and generated during the substrate-induced nucleation reaction. The reactor 302 further includes a set of third output ports 320 located between the lowest and the highest ends of the reactor 302 at different elevations. The third output ports 320 are configured to primarily facilitate the communication of a diluted slurry out of the reactor 302. In some instances, the diluted slurry at the ports 320 includes carbonate crystal precipitates and the processed seawater.

During operation, the input seawater is received at the first input port 312 of the reactor 302; and once it is in contact with the substrates 310, a substrate-induced nucleation reaction occurs at the structured templates on surfaces of the substrates 310, during which carbonate crystal precipitates and carbon dioxide gas form within the reactor 302. Some of the carbonate crystal precipitates may agglomerate together forming larger and heavier particles which can settle down toward the lower levels of the reactor 302, while smaller and lighter carbonate crystal precipitates can remain suspended at higher levels of the reactor 302. A diluted slurry of the processed seawater and carbonate crystal precipitates with different ratios between the liquid (e.g., the processed seawater) and solid (e.g., carbonate crystal precipitates) can be formed in the section between the lowest and the highest ends of the reactor 302. The ports 320 are configured to remove the diluted slurry from the reactor 302. In some instances, the diluted slurry communicated out of the port 320 may include a portion of the reacted substrates 310 that remain small and light which may be suspended in the reactor 302 under the liquid flow condition. In certain examples, the removal of the diluted slurry at the ports 320 is periodic or intermittent according to a predetermined time period. In some instances, the removal of the diluted slurry from the ports 320 may be triggered in response to a predefined criteria being met during a measurement operation or in another manner. The regenerated substrates can be carried by a liquid medium (e.g., the product seawater from the acidification process) back to the reactor 302 from the acidification vessel 304 via the second input port 318. In some instances, the ports 320 may not be continuously open for extracting the diluted slurry that contains carbonate crystal precipitates and the processed seawater from the reactor 302. As the concentration of the carbonate crystal precipitates increases over time, the ports 320 may be opened to transport the diluted slurry out of the reactor 302. In some instances, when the return port 318 is open and the regenerated substrates are returned to the reactor 302, the ports 320 may be closed.

Due to the high concentrations of Ca²⁺ and Mg²⁺ ions in the input seawater, the substrates 310 and the carbonate crystal precipitates may form dense and heavy agglomeration product (e.g., solids) over time that may not remain suspended, which may settle at the lowest section of the reactor 302. In some instances, the dense slurry containing the agglomeration product from the lowest end of the reactor 302 can be periodically or intermittently communicated out of the reactor 302 to the acidification vessel 304. The acidification process can separate the substrates from the carbonate crystal precipitates and regenerate the substrates. In some instances, the regenerated substrates may be returned to the reactor 302 via the return port 318.

In some instances, the liquid flow condition (e.g., velocity) within the reactor 302 can be controlled and adjusted to enhance the capture and removal of carbonate crystal precipitates at the ports 320. In some instances, the diluted slurry may be filtered before passing out of the port 320 to remove the substrates from which the carbonate crystal precipitates are detached. In some implementations, the substrates 310 are also configured in the reactor 302 for efficient water flow and micro-crystal discharge. The example DOC system 300 is configured to remove the DIC from input seawater through an alkaline route where carbonate crystal precipitates are removed after the substrate-induced nucleation reaction, as represented by equation (1).

As shown in FIG. 3, the diluted slurry from the ports 320 is communicated to the acidification vessel 304 where an acid solution can be mixed with the captured crystal precipitates to release carbon dioxide gas. The carbon dioxide gas can be extracted using a vacuum pump or blower and collected for later processing. Residual dissolved carbon dioxide gas may remain in the product seawater from the acidification vessel 304. The product seawater from the acidification vessel 304 is then communicated to the degassing vessel 306 where the residual dissolved carbon dioxide gas can be separated in a subsequent degassing step. In some instances, the acidification vessel 304 and the degassing vessel 306 may be combined into one vessel where the acidification and degassing can be performed during a single operation.

In some implementations, the degassing vessel 304 includes a vacuum column where a vacuum pressure is applied to extract the dissolved carbon dioxide gas from the processed seawater. In some implementations, the degassing vessel 304 includes a bubbe column where a CO₂-lean carrier gas (e.g., air, nitrogen, etc.) is bubbled through the processed seawater to extract the dissolved carbon dioxide gas. In some implementations, the degassing vessel 304 includes a contact module including one or more carbon dioxide selective membranes where the dissolved carbon dioxide gas is selectively transported from the processed seawater on one side of one or more membranes to the opposite side of the one or more membranes. In some instances, an atmospheric extraction method can be used to degas the processed seawater for extracting the dissolved carbon dioxide gas. In some instances, another type of degassing vessel for performing another degassing process may be used. In some instances, the degassing vessel 306 may be implemented as the degassing vessel 204 in the example DOC system 200 in FIG. 2 or in another manner.

In some implementations, the processed seawater at different output ports (e.g., the processed seawater at the port 314, in the diluted slurry at the ports 320, and in the dense slurry at the port 316) also includes dissolved carbon dioxide gas which is the byproduct of the nucleation-assisted crystallization reaction on the substrates 310. As shown in FIG. 3, the processed seawater at the second output port 314 is communicated to the degassing vessel 306 to extract and collect the dissolved carbon dioxide gas from the processed seawater.

In some instances, the example DOC system 300 may include devices or subsystems that can be configured to monitor the suspension of particles in the reactor 302. For example, the example DOC system 300 may include a control system that includes data processing apparatus that is communicably connected to sensors (e.g., pH sensor, pressure sensors, optical sensors, ultrasound sensors, imaging sensors, or other sensors to measure or visualize particle distribution, bubbling, slugging, solid distribution and movement, measure pH values, or measure other conditions in the reactor 302. In some instances, the control system may be connected to devices and components that can be used to adjust and control the fluidizing condition in the reactor 302. In some instances, the control system can be configured to prevent settling, maintain fluidization state, avoid excessive substrate loss, ensure efficient mixing and reaction rate, and optimize the process performance. In some instances, the control system of the DOC system 300 may be also used to communicate with other devices and subsystems (e.g., the liquid circulation subsystem and the gas collection subsystem) to control the reaction conditions and perform the operations in the acidification vessel 304 and the degassing vessel 306. In some instances, the control system may be used for other functions.

In some instances, the example DOC system 300 may perform the degassing reaction in the reactor 302 without transferring the processed seawater out to a separate degassing vessel 306. In this case, the reactor 302 may be connected to a gas collection subsystem that can perform the degassing operation. In some instances, the reactor 302 may be connected to vacuum pumps for performing vacuum extraction. In some examples, the reactor 302 may be connected to one or more gas distributors for receiving a CO₂-lean carrier gas and performing gas extraction (e.g., air extraction or inert gas extraction). In some instances, the gas collections subsystem may include units or components that can further extract the carbon dioxide gas from the product gas before being stored for later processing. In some instances, the vacuum extraction and gas extraction can be simultaneously performed in the reactor 302 to enhance degassing efficiency. In this case, the reactor 302 may be connected to a vacuum pump and one or more gas distributor for performing vacuum-assisted gas extraction. When the degassing is performed in the reactor 302, the processed seawater transferred out of the output port 314 of the reactor 302 may not include a significant amount of dissolved carbon dioxide.

FIG. 4 is a schematic diagram showing an example DOC system 400. The example DOC system 400 includes a reactor 402 configured to receive input seawater and process the input seawater by sustaining a substrate-induced nucleation process on a surface of a substrate in direct contact with the input seawater to produce processed seawater. In some implementations, the example DOC system 400 is a single-step solution processing system, e.g., a single reactor that performs both precipitation and CO₂ extraction simultaneously. As shown in FIG. 4, the reactor 402 is a hollow fiber membrane contactor which includes an array of hollow fiber membranes 404. As further shown in FIG. 4, template-assisted crystallization substrates 410 in the form of particles are loaded and attached to surfaces of the hollow fiber membranes 404 on shell sides. In some implementations, a template-assisted crystallization substrate 410 includes structured template to facilitate the nucleation and growth of crystals. In some instances, the template-assisted crystallization substrates 410 may be implemented as the substrate 110, 210, 310 in FIGS. 1-3 or in another manner.

In some instances, the example DOC system 400 is configured to perform operations in the example process 500 shown in FIG. 5. The example DOC system 400 may include additional or different features, and the components of the example DOC system 400 may operate as described with respect to FIG. 1 or in another manner. For example, the example DOC system 400 further includes a gas collection subsystem and a liquid circulation subsystem which are fluidically connected to each other and to the reactor 402 through liquid pipelines/channels, gas conduits, etc. In some implementations, the gas collection subsystem may be configured to create a driving force for extracting the carbon dioxide gas from the processed seawater and to collect the extracted carbon dioxide gas from the reactor 402; and the liquid circulation subsystem may be configured to cause the input seawater to flow into the reactor 402 and cause the processed seawater to flow out of the reactor 402.

During operation, crystals 408 including carbon crystal precipitates form on these substrates 410 at structured templates (e.g., the structure template 112 on the substrate 110 as shown in FIG. 1) and subsequently detach from the substrates 410. At the same time, carbon dioxide gas is generated with at least a portion being dissolves in the processed seawater. In some implementations, the hollow fiber membranes 410 contact the input seawater at the shell sides and selectively permeate the dissolved carbon dioxide gas in the processed seawater to transport across the hollow fiber membranes 404 to lumen sides. The dissolved carbon dioxide gas can be collected from the lumen sides of the hollow fiber membranes 404 of the reactor 402. The process performed in the example DOC system 400 represents an acid route where CO₂ gas is removed after the substrate-induced nucleation reaction (equation 2).

In some implementations, the input seawater or the processed seawater, in addition to the dissolved carbon dioxide gas, also includes other gases such as nitrogen gas, and oxygen gas. In some implementations, each hollow fiber membrane 404 includes a carbon dioxide selective material. The carbon dioxide selective material in the hollow fiber membrane 404 has a selectivity of the dissolved carbon dioxide in the input seawater over other dissolved gases in the input seawater (e.g., oxygen, nitrogen, etc.). In some implementations, the selectivity of the carbon dioxide selective layer of permeating CO₂ over N₂ or O₂ (e.g., permeability of CO₂/permeability of N₂ or O₂) is greater than 1. In some implementations, the selectivity for separating dissolved carbon dioxide gas from oxygen or nitrogen is in a range of 5 and 30. For example, the selectivity of the carbon dioxide selective layer of permeating CO₂ over N₂ (e.g., permeability of CO₂/permeability of N₂) is in the ranges of 3.4-9.5; and the selectivity of carbon dioxide selective layer of permeating CO₂ over 02 (e.g., permeability of CO₂/permeability of N₂) and 2.4-4.8. During operation, as the input seawater flows through one or more liquid inlets to one or more liquid outlets of the liquid pathway in the reactor 402 and vacuum or gas sweep applied in the gas pathway in the reactor 402, the concentration of the dissolved carbon dioxide gas in the processed seawater in the reactor 402 decreases in the direction of the liquid flow.

In some instances, the hollow fiber membranes 404 may be composed of a single layer of carbon dioxide selective material or can be a composite of two or more different layers made of dissimilar materials. Surfaces of the hollow fiber membranes 404 on the shell sides can be preferably hydrophobic to repel water, and the hollow fiber membranes 404 can have pores in nanometers or sub nanometers (or nonporous). In the case of a composite hollow fiber membranes 404 at least one layer is hydrophobic, and one or more layers can have different pore sizes. In some implementations, the hollow fiber membranes 404 have inner and outer diameters in the ranges of 50-2000 micrometers (μm) and 150-3000 μm, respectively, or have a ratio of outer diameter to inner diameter in the range of 1.3-2. In some instances, hollow fiber membranes 404 with different sizes may be used in a module 124.

In some instances, each hollow fiber membrane 404 has a multilayer composite membrane structure. For example, the hollow fiber membrane 404 includes a supporting layer and a carbon dioxide selective layer disposed on a first surface of the supporting layer. In a hollow fiber membrane with a multilayer composite membrane structure, the thickness of the supporting layer may be equal to or greater than 10, 50, 100, 200 micrometers or another value, and the thickness of the carbon dioxide selective layer may be equal to or less than 50, 20, 10 micrometers, or another value. In some implementations, the hollow fiber membrane 404 has stable chemical and mechanical stability under the operation condition of the modular DOC system 400, e.g., under vacuum, under a certain pressure differential created by the gas collection subsystem, in contact with a flowing seawater, etc. In some implementations, the hollow fiber membrane 404 includes a polymer or polymer mixture configured to reduce the solubility of water/water vapor in the carbon dioxide selective layer and reduce water transport while maintaining the efficient transport of carbon dioxide gas.

In some implementations, each hollow fiber membrane 404 may include a single layer of a silicone-based polymer, a single layer of a polyolefins-based polymer, a single layer of a fluoropolymer, a single layer of polyacetylene derived polymers, or a single layer of another type of carbon dioxide selective material. In certain examples, each hollow fiber membrane 404 may include a single layer of a mixture of two or more of the following materials, a silicone-based polymer, a polyolefins-based polymer, a fluoropolymer, a polyacetylene derived polymer, or another type of carbon dioxide selective material. In some examples, each hollow fiber membrane 404 may include two or more layers of the following materials, including a silicone-based polymer, a polyolefins-based polymer, a fluoropolymer, or another type of carbon dioxide selective material. The silicon-based polymer includes polydimethylsiloxane (PDMS), or another silicon-based polymer; the polyolefins-based polymer includes polymethylpentene (PMP), or another polyolefins-based polymer; the fluoropolymer includes polytetrafluoroethylene (PTFE) or another type of fluoropolymer; and the polyacetylene derived polymer includes poly(1-trimethylsilyl-1-propyne) (PTMSP) or another type of polyacetylene derived polymer.

In some examples, the supporting layer in the hollow fiber membrane 404 may include a single layer of polysulfone (PSf), a single layer of polyethersulfone (PES), a single layer of polyvinylidene fluoride (PVDF), a single layer of a ceramic material, or a single layer of another material. In some instances, the supporting layer includes a single layer of a mixture of two or more of the following materials, including polysulfone (PSf), polyethersulfone (PES), polyvinylidene fluoride (PVDF), a ceramic material, or another material. In some instances, the supporting layer includes two or more layers of the following materials, including polysulfone (PSf), polyethersulfone (PES), polyvinylidene fluoride (PVDF), a ceramic material, or another material.

In some instances, the supporting layer has a porous structure; and the stacking of the carbon dioxide selective layer on the porous structure of the supporting layer may result in a different overall interface structure of the hollow fiber membrane 404. For example, the carbon dioxide selective layer in the hollow fiber membrane 404 may have an abrupt interface with the supporting layer. In this case, the surface pores of the porous supporting layer may not be filled with the carbon oxide selective layer. For another example, the surface pores of the porous supporting layer in the hollow fiber membrane 404 may be partially or completely filled with the carbon dioxide selective layer. In some instances, the array in the reactor 402 may include hollow fiber membranes 404 that have different structures, compositions, interface structures, or other properties.

In some implementations, the fiber packing density in the reactor 402 can be defined as cross sectional area occupied by the hollow fiber membranes divided by the total cross-sectional area for hollow fiber membrane module in the plane perpendicular to the orientation direction of the hollow fiber membranes 404, which can be determined according to the dimension (e.g., outer diameter, inner diameter, thickness, etc.) of each hollow fiber membrane 404. In some instances, the active area of a hollow fiber membrane module is defined by the total surface area of the hollow fiber membranes 404 in the reactor 402. In some instances, the active surface area of the reactor 402 is determined by the outer diameter of the hollow fiber membranes, the number of hollow fiber membranes 404 and the effective length of the hollow fiber membranes 404, etc.

As shown in FIG. 4, the reactor 402 further includes gas manifolds 406 fluidically connected to two open ends of the hollow fiber membranes 404 to allow a vacuum to be applied to lumen sides, facilitate sweep gas flow into and out of the lumen sides, and facilitates the transported carbon dioxide gas from the processed seawater out of the lumen sides of the hollow fiber membranes 404. In some instances, gas manifolds 406 of the reactor 402 are fluidically connected to external gas pipelines of the example DOC system 400. In some implementations, joints at the hollow fiber membranes 404 and the gas manifolds 406 are sealed for maintaining vacuum integrity and preventing solution leakage into the gas manifolds 406. As shown FIG. 4, both ends of each hollow fiber membrane 404 are open. Potting layers 408 are applied in regions adjacent to the open ends of the hollow fiber membranes 404 to prevent the processed seawater flowing into the gas manifold 406. In some instances, the potting layer 408 may include curable resin such as epoxy or polyurethane or other material. In some implementations, the hollow fiber membranes 404 separates the liquid pathway on the shell sides and a gas pathway on the lumen sides.

Over time, crystal deposits may detach from the surfaces of the substrates 410 and form the carbonate crystal precipitates; and the substrates 410 can be regenerated for subsequent formation of crystal deposits on these substrates 410 at structured templates. Since the dissolved carbon dioxide gas in the processed seawater is extracted by operation of the hollow fiber membranes 404, the processed seawater from the reactor 400 is CO₂-lean and includes the carbonate crystal precipitates. The processed seawater flowing out of the reactor 400 at an outlet may in the form of a diluted slurry containing the carbonate crystal precipitates, and can be filtered or clarified. The carbonate crystal precipitates can be collected and stored for later process. In some instances, the collected carbonate crystal precipitates can be further acidified and converted into carbon dioxide gas which can be stored or used in a later process. The processed seawater after the carbonate crystal precipitates removed can be communicated back to the ocean.

In certain examples, the carbonate crystal precipitates may be built up on the substrates 410, the surfaces of the hollow fiber membranes 404, between the hollow fiber membranes 404, or other surfaces inside the reactor 402. In this case, a stream of cleaning solution including acid can be periodically communicated to the reactor 402 to chemically remove buildup crystals, regenerate the substrate 410, and the hollow fiber membranes 404. In some instances, the cleaning process may be triggered or performed in another manner.

FIG. 5 is an example flow chart showing aspects of an example process 500. The example process 500 can be used, for example, to operate a DOC system, e.g., the example DOC system 100, 200, 300, 400 as shown in FIGS. 1-4. For instance, the example process 500 can be used to perform removal of DIC directly from seawater using substrates based on a substrate-induced nucleation reaction. The example process 500 may include additional or different operations, including operations performed by additional or different components, and the operations may be performed in the order shown or in another order. In some implementations, one or more operations in the example process 500 can be performed by a computer system, for instance, by a digital computer system having one or more digital processors (e.g., data processing apparatus of a control system of the example DOC system 100 in FIG. 1) that execute instructions (e.g., instructions stored in the memory unit of a control system of the example DOC system 100 in FIG. 1).

At 502, the input seawater is passed to a reactor. In some instances, prior to being passed to the reactor, the input seawater may be collected and preprocessed. For example, surface seawater may be collected from the ocean. In some instances, the obtained seawater may be pre-treated to remove any impurities, debris, or contaminants. In some implementations, the DIC in the input seawater is in the form of inorganic carbon, e.g., carbonate and bicarbonate. In some instances, the reactor includes substrates that include structure templates to facilitate the nucleation and growth of crystals.

At 504, a substrate-induced nucleation process is performed on a surface of a substrate. In some implementations, the input seawater is directed to the reactor to contact substrates that include structured templates and is processed in the reactor. The substrate-induced nucleation process causes crystals, including carbon crystals, to form on the substrates at the structured templates (e.g., the structure template 112 on the substrate 110 as shown in FIG. 1). In some instances, the crystals may subsequently detach from the substrates and form carbonate crystal precipitates in the solution. At the same time, carbon dioxide gas is generated, and at least a portion can be dissolved in the processed seawater. In some instances, the reactor may be a fluidized bed reactor or a hollow fiber membrane contactor; and the substrates may be suspended in the fluidized bed reactor, or supported on surfaces of the hollow fiber membranes. In some instances, the substrates may be loaded in the reactor in another manner.

At 506, at least a portion of the dissolved carbon dioxide gas in the processed seawater is collected. In some instances, at least a portion of the generated carbon dioxide gas is dissolved in the processed seawater directly from the reactor or in a separate degassing vessel (FIGS. 2 and 4). In some instances, at least a portion of the dissolved carbon dioxide gas from the substrate-induced nucleation reaction in the processed seawater from the reactor can be collected from the processed seawater. In some instances, at least a portion of carbon dioxide gas collected may include carbon dioxide gas generated from an acidification process of the carbonate crystal precipitates and/or from a regeneration process of the reacted substrates in an acidification vessel separated from the reactor (FIG. 3). In some instances, at least a portion of carbon dioxide gas may be collected in another manner according to the type of substrates, type of reactors, operation conditions, degassing methods, etc.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a substrate-induced nucleation process is used for direct removal of carbon dioxide in seawater that contains dissolved inorganic carbon.

In a first example, a method of removing carbon dioxide from seawater includes in a reactor comprising a substrate, receiving seawater comprising dissolved inorganic carbon; and processing the seawater in the reactor by performing a substrate-induced nucleation process on a surface of the substrate. The substrate-induced nucleation process transforms the dissolved inorganic carbon to carbonate crystal precipitates and carbon dioxide gas. The method further includes extracting at least a portion of the carbon dioxide gas from the processed seawater.

Implementations of the first example may include one or more of the following features. Extracting the at least a portion of the carbon dioxide gas from the processed seawater includes tuning a pH of the processed seawater to control a reaction rate of the substrate-induced nucleation process. The substrate-induced nucleation process is performed on a surface of a nucleation-assisted crystallization substrate or a template-assisted crystallization substrate. The reactor includes hollow fiber membranes which have respective shell sides and respective lumen sides. The substrate is attached to the respective shell sides of the hollow fiber membranes. The processed seawater includes the carbon dioxide gas. Extracting at least a portion of the carbon dioxide gas from the processed seawater includes selectively transporting at least a portion of the carbon dioxide gas from the processed seawater from the respective shell sides to the respective lumen sides of the hollow fiber membranes; and collecting the transported carbon dioxide from the lumen sides of the hollow fiber membranes.

Implementations of the first example may include one or more of the following features. The reactor includes a fluidized bed reactor. The substrate includes particles suspended in the fluidized bed reactor. Performing the substrate-induced nucleation process includes forming at least a portion of the carbonate crystal precipitates on the surface of the particles. The method further includes by operation of a liquid circulation subsystem, receiving a slurry from the reactor; acidifying the slurry. Acidifying the processed seawater removes the carbonate crystal precipitates from the surfaces of the particles, regenerates the particles and forms product seawater. The method further includes filtering the regenerated particles from the product seawater; and communicating the regenerated particles back to the reactor. The product seawater includes dissolved carbon dioxide gas, and the method includes degassing at least a portion of the dissolved carbon dioxide gas from the product seawater.

Implementations of the first example may include one or more of the following features. Extracting at least a portion of the carbon dioxide gas from the processed seawater includes, by operation of a gas collection subsystem, degassing at least a portion of the carbon dioxide gas from the processed seawater. Degassing at least a portion of the carbon dioxide gas from the processed seawater includes, by operation of the gas collection subsystem, bubbling a carrier gas through the processed seawater to cause the carrier gas to extract at least a portion of the carbon dioxide gas; and collecting a product gas comprising the extracted carbon dioxide gas.

Implementations of the first example may include one or more of the following features. Performing the substrate-induced nucleation process includes forming the carbonate crystal precipitates on the surface of the substrate; and causing the carbonate crystal precipitates to detach from the surface of the substrate to the processed seawater. The method includes, by operation of a liquid circulation subsystem, collecting a slurry which includes the detached carbonate crystal precipitates from the reactor; and acidifying the slurry to convert the detached carbonate crystal precipitates to carbon dioxide gas. The method further includes, by operation of a gas collection subsystem, collecting the generated carbon dioxide gas from the liquid circulation subsystem.

In a second example, a direct ocean capture system includes a reactor, a substrate, and a gas collection subsystem. The reactor is configured to process seawater comprising dissolved inorganic carbon. The substrate is disposed in the reactor; and the substrate includes a surface configured to contact the seawater and produce a substrate-induced nucleation process that transforms the dissolved inorganic carbon to carbonate crystal precipitates and carbon dioxide gas. The gas collection subsystem is configured to receive processed seawater from the reactor; and extract at least a portion of the carbon dioxide gas from the processed seawater.

Implementations of the second example may include one or more of the following features. The gas collection subsystem is configured to tune a pH of the processed seawater to control a reaction rate of the substrate-induced nucleation process. The substrate includes a nucleation-assisted crystallization substrate or a template-assisted crystallization substrate. The reactor includes hollow fiber membranes having respective shell sides and respective lumen sides. The substrate is attached to the respective shell sides of the hollow fiber membranes. The processed seawater includes the carbon dioxide gas. Extracting at least a portion of the carbon dioxide gas from the processed seawater includes selectively transporting the carbon dioxide gas from the processed seawater from the respective shell sides to the respective lumen sides of the hollow fiber membranes; and collecting the transported carbon dioxide from the lumen sides of the hollow fiber membranes.

Implementations of the second example may include one or more of the following features. The reactor includes a fluidized bed reactor. The substrate includes particles suspended in the fluidized bed reactor. Producing the substrate-induced nucleation process includes forming at least a portion of the carbonate crystal precipitates on the surface of the particles. The system includes a liquid circulation subsystem configured to receive a slurry from the reactor; acidify the slurry to remove the carbonate crystal precipitates from the surfaces of the particles, to regenerate the particles, and to form product seawater; separate the regenerated particles from the product seawater; and communicate the regenerated particles back to the reactor. The product seawater includes dissolved carbon dioxide gas, and the gas collection subsystem is configured to degas at least a portion of the dissolved carbon dioxide gas from the product seawater.

Implementations of the second example may include one or more of the following features. The gas collection subsystem is configured to degas at least a portion of the carbon dioxide gas from the processed seawater. Degassing at least a portion of the carbon dioxide gas from the processed seawater includes bubbling a carrier gas through the processed seawater to cause the carrier gas to extract at least a portion of the carbon dioxide gas; and collecting a product gas comprising the extracted carbon dioxide gas.

Implementations of the second example may include one or more of the following features. Producing the substrate-induced nucleation process includes forming the carbonate crystal precipitates on the surface of the substrate; and causing the carbonate crystal precipitates to detach from the surface of the substrate to the processed seawater. The system includes a liquid circulation subsystem configured to collect a slurry which includes the detached carbonate crystal precipitates from the reactor; and acidify the slurry to convert the detached carbonate crystal precipitates to carbon dioxide gas. The gas collection subsystem is configured to collect the carbon dioxide gas from the liquid circulation subsystem.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method of removing carbon dioxide from seawater, the method comprising:
in a reactor comprising a substrate, receiving seawater comprising dissolved inorganic carbon;
processing the seawater in the reactor, wherein processing the seawater comprises performing a substrate-induced nucleation process on a surface of the substrate, and the substrate-induced nucleation process transforms the dissolved inorganic carbon to carbonate crystal precipitates and carbon dioxide gas; and
extracting at least a portion of the carbon dioxide gas from the processed seawater.

2. The method of claim 1, wherein the reactor comprises a fluidized bed reactor, the substrate comprises particles suspended in the fluidized bed reactor, performing the substrate-induced nucleation process comprises forming at least a portion of the carbonate crystal precipitates on the surface of the particles, and the method comprises:
by operation of a liquid circulation subsystem:
receiving a slurry comprising the particles from the reactor;
acidifying the slurry, wherein acidifying the slurry removes the carbonate crystal precipitates from the surfaces of the particles, regenerates the particles and forms product seawater;
filtering the regenerated particles from the product seawater; and
communicating the regenerated particles back to the reactor.

3. The method of claim 2, wherein the product seawater comprises dissolved carbon dioxide gas, and the method comprises degassing at least a portion of the dissolved carbon dioxide gas from the product seawater.

4. The method of claim 1, wherein extracting at least a portion of the carbon dioxide gas from the processed seawater comprises, by operation of a gas collection subsystem, degassing at least a portion of the carbon dioxide gas from the processed seawater.

5. The method of claim 4, wherein degassing at least a portion of the carbon dioxide gas from the processed seawater comprises:
by operation of the gas collection subsystem,
bubbling a carrier gas through the processed seawater to cause the carrier gas to extract at least a portion of the carbon dioxide gas; and
collecting a product gas comprising the extracted carbon dioxide gas.

6. The method of claim 1, wherein performing the substrate-induced nucleation process comprises:
forming the carbonate crystal precipitates on the surface of the substrate; and
causing the carbonate crystal precipitates to detach from the surface of the substrate to the processed seawater.

7. The method of claim 6, comprising:
by operation of a liquid circulation subsystem,
collecting a slurry from the reactor, the slurry comprising the detached carbonate crystal precipitates; and
acidifying the slurry to convert the detached carbonate crystal precipitates to carbon dioxide gas.

8. The method of claim 7, comprising:
by operation of a gas collection subsystem, collecting the generated carbon dioxide gas from the liquid circulation subsystem.

9. The method of claim 1, wherein extracting the at least a portion of the carbon dioxide gas from the processed seawater comprises:
tuning a pH of the processed seawater to control a reaction rate of the substrate-induced nucleation process.

10. The method of claim 1, wherein the substrate-induced nucleation process is performed on a surface of a nucleation-assisted crystallization substrate or a template-assisted crystallization substrate.

11. The method of claim 1, wherein the reactor comprises hollow fiber membranes comprising respective shell sides and respective lumen sides, the substrate is attached to the respective shell sides of the hollow fiber membranes, the processed seawater comprises the carbon dioxide gas, and extracting at least a portion of the carbon dioxide gas from the processed seawater comprises:
selectively transporting at least a portion of the carbon dioxide gas from the processed seawater from the respective shell sides to the respective lumen sides of the hollow fiber membranes; and
collecting the transported carbon dioxide from the lumen sides of the hollow fiber membranes.

12. A direct ocean capture system comprising:
a reactor configured to process seawater comprising dissolved inorganic carbon;
a substrate disposed in the reactor, the substrate comprising a surface configured to contact the seawater and induce a nucleation process that transforms the dissolved inorganic carbon to carbonate crystal precipitates and carbon dioxide gas; and
a gas collection subsystem configured to:
receive processed seawater from the reactor; and
extract at least a portion of the carbon dioxide gas from the processed seawater.

13. The system of claim 12, wherein the reactor comprises a fluidized bed reactor, the substrate comprises particles suspended in the fluidized bed reactor, producing the substrate-induced nucleation process comprises forming at least a portion of the carbonate crystal precipitates on the surface of the particles, and the system comprises a liquid circulation subsystem configured to:
receive a slurry comprising the particles from the reactor;
acidify the slurry to remove the carbonate crystal precipitates from the surfaces of the particles, to regenerate the particles, and to form product seawater;
separate the regenerated particles from the product seawater; and
communicate the regenerated particles back to the reactor.

14. The system of claim 13, wherein the product seawater comprises dissolved carbon dioxide gas, and the gas collection subsystem configured to degas at least a portion of the dissolved carbon dioxide gas from the product seawater.

15. The system of claim 12, where the gas collection subsystem is configured to degas at least a portion of the carbon dioxide gas from the processed seawater.

16. The system of claim 15, wherein degassing at least a portion of the carbon dioxide gas from the processed seawater comprises:
bubbling a carrier gas through the processed seawater to cause the carrier gas to extract at least a portion of the carbon dioxide gas; and
collecting a product gas comprising the extracted carbon dioxide gas.

17. The system of claim 12, wherein producing the substrate-induced nucleation process comprises:
forming the carbonate crystal precipitates on the surface of the substrate; and
causing the carbonate crystal precipitates to detach from the surface of the substrate to the processed seawater.

18. The system of claim 17, comprising a liquid circulation subsystem configured to:
collect a slurry from the reactor, the slurry comprising the detached carbonate crystal precipitates; and
acidify the slurry to convert the detached carbonate crystal precipitates to carbon dioxide gas.

19. The system of claim 18, wherein the gas collection subsystem is configured to collect the carbon dioxide gas from the liquid circulation subsystem.

20. The system of claim 12, wherein the gas collection subsystem is configured to tune a pH of the processed seawater to control a reaction rate of the substrate-induced nucleation process.

21. The system of claim 12, wherein the substrate comprises a nucleation-assisted crystallization substrate or a template-assisted crystallization substrate.

22. The system of claim 12, wherein the reactor comprises hollow fiber membranes comprising respective shell sides and respective lumen sides, the substrate is attached to the respective shell sides of the hollow fiber membranes, the processed seawater comprises the carbon dioxide gas, and extracting at least a portion of the carbon dioxide gas from the processed seawater comprises:
selectively transporting the carbon dioxide gas from the processed seawater from the respective shell sides to the respective lumen sides of the hollow fiber membranes; and
collecting the transported carbon dioxide from the lumen sides of the hollow fiber membranes.
